(19) United States
(12) Patent Application Publication
(10) Pub. No.: US 2003/0002451 A1
(43) Pub. Date: Jan. 2, 2003

(54) Method and system for transferring data between at least one read/write device and at least one data memory in an identification system using a time-slot pattern predetermined by the read/write device

(75) Inventors: Wolfgang Konrad, Moedling (AU); Wolfgang Pusch, Vienna (AU); Martin Schiefer, St. Poelten (AU); Peter-Ernst Veith, Vienna (AU)

Correspondence Address: SUGHRUE MION, PLLC, 2100 Pennsylvania Avenue, NW, Washington, DC, 20037-3213, US

(73) Assignee: SIEMENS AKTIENGESELLSCHAFT

(21) Appl. No.: 10/164,406

(22) Filed: Jun. 10, 2002

Related U.S. Application Data
(63) Continuation of application No. PCT/EP00/11745, filed on Nov. 24, 2000.

(30) Foreign Application Priority Data
Dec. 9, 1999 (DE) 299 214 64.8
Dec. 9, 1999 (EP) 991 245 38.2

(51) Int. Cl. G05B 23/02; H04Q 7/00; G06K 7/10; H04J 3/00

(52) U.S. Cl. 370/314; 370/345; 340/3.21; 235/472.02

(57) ABSTRACT

A method for transferring data between at least one read/write device (RWD) and at least one mobile data memory (MDM) in an identification system, using at least one mobile data memory (MDM) that is attached to an object for recording object-related status and/or process data, e.g., in a dispatch, transport and/or manufacturing system for the individual items. According to the method, a time-slot structure for transferring data to the mobile data memory (MDM) is predetermined in the read/write device (RWD).

This is a Continuation of International Application PCT/EPOO/11745, with an international filing date of Nov. 24, 2000, which was published under PCT Article 21(2) in German, and the disclosure of which is incorporated into this application by reference.

### FIELD OF AND BACKGROUND OF THE INVENTION

The invention relates to a method and a system for transferring data between at least one read/write device and at least one mobile data memory in an identification system with at least one data memory attached to at least one object for detecting object-related data of the at least one object

Identification systems known from the prior art include at least one stationary read/write device for contactless data exchange with mobile data memories, typically by means of a radio-based data transfer link. Such systems are used in technical installations where a plurality of objects or goods must be moved, and possibly otherwise processed, as quickly and freely as possible. The objects can range through the widest variety of types, e.g., packages in a dispatch system, assembly components in a manufacturing system, luggage in a transport system, moving vehicles, etc. As a rule it is necessary, at defined locations within the system, e.g., a manufacturing plant, to determine quickly and freely, for instance, the type, condition and/or status of the objects actually found in spatial proximity to these locations. For this purpose, the objects on the one hand are provided with mobile data memories, which contain, for instance, data that identifies the type, condition and/or current status of the objects. On the other hand, read/write devices are placed at the defined locations within the system and are frequently connected to central data processing equipment.

If such objects, e.g., in the course of manufacture, are transported into spatial proximity of a selected location, the stationary read/write device that is arranged there can contactlessly detect and, if necessary, change the data in the mobile data memories of the objects that are currently within its detection range. The data can then be evaluated for various purposes by means of higher-level central data processing equipment, e.g., to track the path of the objects that are provided with the mobile data memories and, as a function thereof, to control operational equipment of the corresponding technical system.

In the operation of such identification systems, a large quantity of mobile data memories are often simultaneously located within the detection range of one read/write device and must be addressed. Furthermore, the problem may occur that communication is not established with all the mobile data memories in a given time unit, such that some mobile data memories may have left the detection range of the read/write device before the required communication with the read/write device has taken place. This may have various undesirable effects, from simple data loss to a massive disruption in the operations of a production system.

This problem is influenced on the one hand by the number or density of the mobile data memories traversing the detection range of a given read-write device per time unit and on the other hand by the range of the respective read/write device, i.e., its detection range. For reasons of effectiveness, the aim is to select both the density of the mobile data memories and the range of the read/write devices as large as possible. In practice, current efforts are focused especially on increasing the range of an identification system, i.e., particularly the communication range of the read/write devices. This makes it possible to achieve additional degrees of freedom, especially in the construction and operation of technical systems, e.g., manufacturing systems, storage systems, distribution systems, etc.

For identification systems with a range beyond the immediate vicinity, i.e., for instance, a range greater than one half meter, various systems to alleviate the aforementioned problem have been proposed.

In a first system, principles of randomness are used to activate the mobile data memories. However, since this does not completely exclude the possibility that more than one mobile data memory per time unit is enabled, additional coding means must be used to achieve a unique assignment between the read/write devices and mobile data memories and to prevent misreadings. This is costly. Furthermore, the maximum number of mobile data memories that may be present within the reception range of a read/write device of such a system must be strongly restricted. Otherwise, collisions would be unavoidable in this system above a certain number of mobile data memories and with prolonged communication times. These collisions would ultimately block the exchange of data and thus the particular read/write device involved.

In a further prior art system, the mobile data memories located within the reception range of a read/write device are specifically activated by the read/write device. This method is known as sequential polling. This system, too, however, has drawbacks. On the one hand, specific activation causes substantial delays, which impair the communication speed. A significant drawback is that the addresses of the mobile data memories must be known. In each case, a read/write device must continually call all the mobile data memories logged into the system, irrespective of whether they are actually within its detection range.

### OBJECTS OF THE INVENTION

An object of the present invention is to define a method that enables communication, i.e., data exchange, in the most efficient and reliable manner with the largest possible number of mobile data memories per time unit.

### SUMMARY OF THE INVENTION

These and other objects are attained by a method that includes: subdividing the data transfer between a read/write device and at least one mobile data memory into time slots (SLOTS); combining a plurality of the time slots (SLOTS) into a partial frame (PFRAME=SLOT1+SLOT2+. . . +SLOTm) and combining a plurality of the partial frames (PFRAMEx, x=1 . . . n) into one frame (FRAME=PFRAME1+PFRAME2+. . . +PFRAMEn); sending a wakeup code (WUC) from the read/write device to the at least one mobile data memory during a beginning part of at least one time slot (SLOT); and transferring the data between the read/write device and the at least one mobile data memory during the remaining part of the time slot (SLOT). According to another formulation, the invention provides an identification system that includes: a read write device; a plurality of objects in motion; and a plurality of mobile data memories correlated with the objects. The read write device is configured with at least one of hardware or software to transmit wakeup codes to the mobile data memories during beginning parts of respective time slots and to transfer data between the read write device and the mobile data memories during remaining parts of the respective time slots. A plurality of the respective time slots are combined into a partial frame and a plurality of the partial frames are combined into a frame, wherein a plurality of the frames are respectively consecutive in time and coordinated in duration.

The data transfer method according to one aspect of the invention structures the data stream between the read/write device and at least one mobile data memory so that, during data transfer, it is not continuous but is subject to a time-slot pattern.

To this end, according to one aspect of the invention, the data stream of the read/write device is first subdivided into frames (FRAMES), which are consecutive in time and have corresponding durations.

Furthermore, each frame (FRAME) of the data stream, according to a further aspect of the invention, is preferably subdivided into partial frames (PFRAMES), which are consecutive in time and have corresponding durations.

Additionally, the partial frames (PFRAMES), according to yet another aspect of the invention, are subdivided into time slots, which are consecutive in time and again have corresponding durations.

The read/write device uses regularly repeated signaling data (CHAS) to inform all the mobile data memories of a system of the subdivision of the data stream into frames (FRAMES), partial frames (PFRAMES) and time slots (SLOTS).

### BRIEF DESCRIPTION OF THE DRAWINGS

Further details of the invention, for transferring data (e.g., adaptation to a large number of mobile data memories or adaptation to a high data transmission rate) will become clear from the exemplary embodiments, which will be described in greater detail with reference to the drawing figures, in which:

FIG. 1 is a schematic representation of a read/write device with mobile data memories located at respective distances from the read/write device; and

FIG. 2 illustrates a structure that allows improved data transfer between the read/write device and the mobile data memories.

### DETAILED DESCRIPTION OF THE PREFERRED EMBODIMENTS

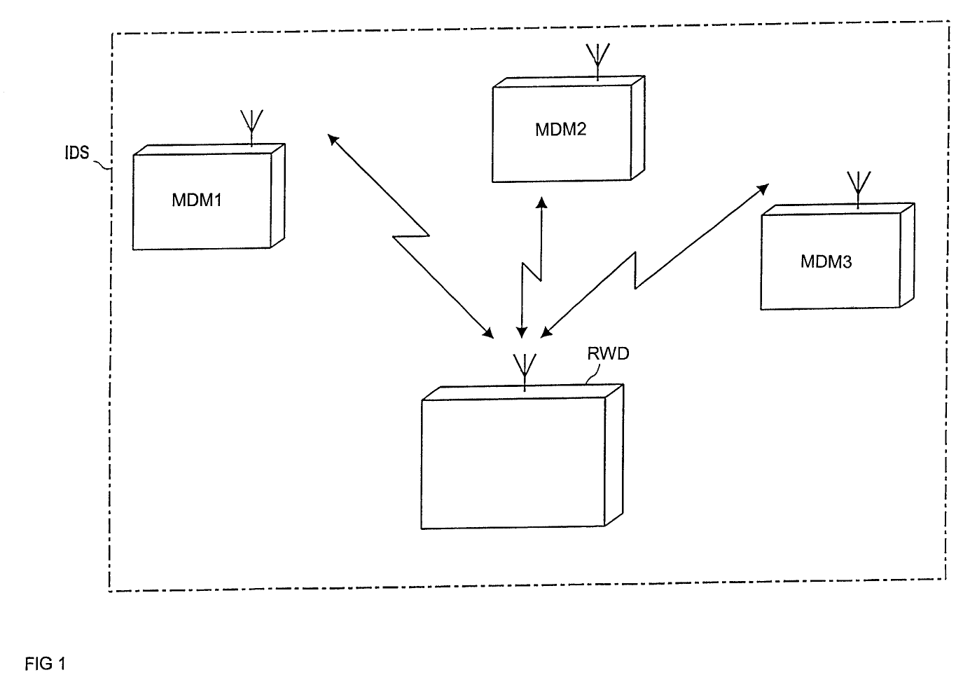

FIG. 1 shows an identification system IDS that includes mobile data memories (MDM 1-3) arranged at various locations, and possibly moving, relative to a read/write device (RWD). The mobile data memories (MDM) communicate with the read/write device (RWD), preferably via radio signals, for the purpose of transferring data at least from the mobile data memories (MDM) to the read/write device (RWD).

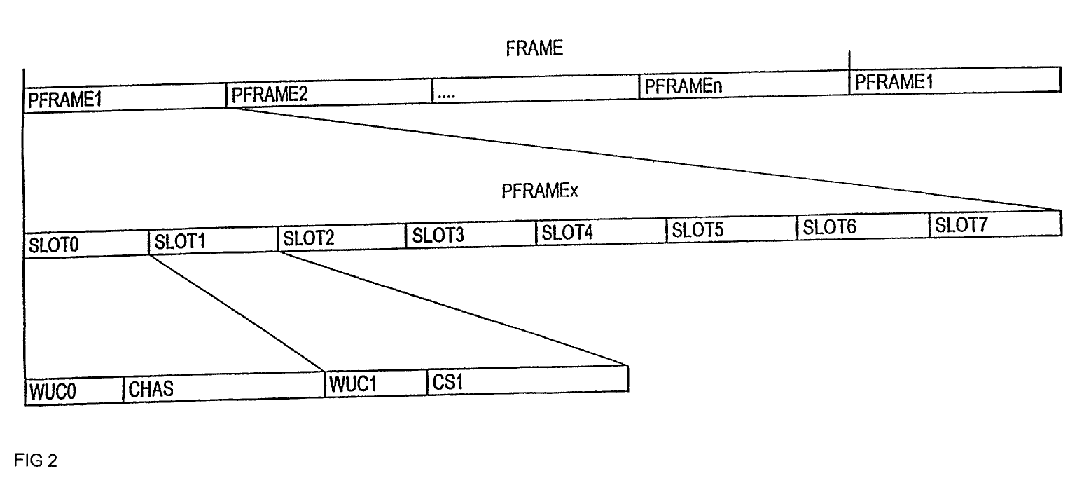

FIG. 2 shows the structure predetermined by the read/write device (RWD) (deterministic structure) of the data transfer between the read/write device (RWD) and the mobile data memory or memories (MDM).

Specifically, the data transfer between the read/write device (RWD) and the mobile data memory (MDM) is subdivided into time slots (SLOTS). At the beginning of each time slot (SLOT), a wakeup code (WUC) is sent and the remaining part of the time slot is used for transferring data between the read/write device (RWD) and the mobile data memory (MDM).

It is possible, in the respective time slots (SLOTS) either to transfer signaling data (CHAS, channel assignment slot)—here in SLOT0—or communication data (CS, communication slot)—here in SLOT1 to SLOT7.

The read/write device (RWD) uses the signaling data (CHAS) to transmit to the mobile data memory (MDM) data for determining the subsequent frame (FRAME) and its time slots (SLOTS) with respect to the data direction (e.g., uplink, downlink) and data content (data, instructions).

In a separate uplink and downlink data transfer from the read/write device (RWD) to the mobile data memory (MDM) and from the mobile data memory (MDM) to the read/write device (RWD), a time division duplex (TDD) method is preferably used.

When the individual time slots (SLOTS) or partial frames (PFRAMES) are assigned to different mobile data memories (MDM), data can be continuously exchanged between one read/write device (RWD) and a relatively large number of mobile data memories (MDM). Such a method is generally designated a time division multiple access (TDMA) method.

The actual content-related data transfer between the read/write device (RWD) and the mobile data memory (MDM) takes place in the respective communication slots (CS).

By means of the signaling data (CHAS), the read/write device (RWD) also indicates subsequent free communication slots (CS), which the mobile data memories (MDM) can use to reply.

If two mobile data memories (MDM) reply simultaneously in a communication slot (CS) that had been signaled to be free, the read/write device (RWD) notes a collision by detecting, for instance, the superposition of data signals provided with non-linear codes of two or more data signals from different mobile data memories (MDM). To eliminate this collision, each colliding mobile data memory (MDM) selects a random number, which determines the transmittal time when a data signal will be retransmitted by the respective mobile data memory (MDM) to the read/write device (RWD).

In the next communication attempt, the individual mobile data memories (MDM) resend data signals to the read/write device (RWD) at different times corresponding to the selected random numbers, so that a renewed collision is avoided or its probability is reduced.

If another collision nevertheless occurs, a definable number of renewed transfer attempts for the individual mobile data memories (MDM) can be determined by the read/write device (RWD) or by the data memories themselves.

The inventive method for transferring data can be adapted to different requirements of the identification system by modifying the time slot structure predetermined by the read/write device (RWD).

In order to provide efficient data transfer with a large number of mobile data memories, a frame (FRAME) is formed from a large number of partial frames (PFRAMES). The number of mobile data memories (MDM) can exceed the number of partial frames (PFRAMES). The number of the partial frames (PFRAMES) and their identification can be transmitted by the read/write device (RWD) via a partial frame number in the time slot (SLOT) for transferring signaling data (CHAS) at the beginning of each partial frame (PFRAME).

This makes it possible to achieve simultaneous data transfer and communication between one read/write device (RWD) and a large number of mobile data memories (MDM).

To optimize the data transfer between the read/write device (RWD) and a mobile data memory (MDM), the data rate and the use of each time slot (SLOT) for transmitting or receiving and for data or instructions within each partial frame (PFRAME) can be set differently for the individual partial frames (PFRAMES) and thus for each mobile data memory (MDM).

Thus the inventive method for transferring data between a read/write device (RWD) and a mobile data memory (MDM) enables reliable communication with the mobile data memories (MDM) by means of the time slot structure predetermined by the read/write device (RWD). As described above, this time slot structure can be adapted to the corresponding data transfer requirements between the read/write device (RWD) and the mobile data memories (MDM).

The above description of the preferred embodiments has been given by way of example. From the disclosure given, those skilled in the art will not only understand the present invention and its attendant advantages, but will also find apparent various changes and modifications to the methods and structures disclosed. It is sought, therefore, to cover all such changes and modifications as fall within the spirit and scope of the invention, as defined by the appended claims, and equivalents thereof.

What is claimed is:

1. Method for transferring data between at least one read/write device and at least one mobile data memory in an identification system with at least one data memory attached to at least one object for detecting object-related data of the at least one object, comprising:
subdividing the data transfer between the read/write device and the at least one mobile data memory into time slots (SLOTS);
combining a plurality of the time slots (SLOTS) into a partial frame (PFRAME=SLOT1+SLOT2+. . . +SLOTm) and combining a plurality of the partial frames (PFRAMEx, x . . . n) into one frame (FRAME=PFRAME1+PFRAME2+. . . +PFRAMEn);
sending a wakeup code (WUC) from the read/write device to the at least one mobile data memory during a beginning part of at least one time slot (SLOT); and
transferring the data between the read/write device and the at least one mobile data memory during the remaining part of the time slot (SLOT).

2. Method as claimed in claim 1, wherein the object-related data comprises at least one of status data and process data.

3. Method as claimed in claim 1, further comprising:
assigning the partial frames (PFRAMEx, x=1 . . . n) to respective ones of a plurality of mobile data memories prior to said transferring of the data between the read/write device and the mobile data memory.

4. Method as claimed in claim 1, wherein, in a first time slot (SLOT), signaling data (CHAS) is sent from the read/write device to the at least one mobile data memory in order to determine a subsequent frame (FRAME) and time slots (SLOTS) of the subsequent frame with regard to data direction and data content.

5. Method as claimed in claim 4, wherein the data direction comprises an uplink direction and a downlink direction, and the data content comprises data, instructions.

6. Method as claimed in claim 4, wherein:
if the identification system includes a large number of mobile data memories, for said transferring of the data, the frame (FRAME) is formed from a large number of the partial frames (PFRAMEx, x=1 . . . n), and
the number of the frames (FRAMES) and an identification (number) of the frames are sent from the read/write device in the time slot (SLOT) for sending the signaling data (CHAS) at the beginning of each partial frame (PFRAMEx, x=1 . . . n).

7. Method as claimed in claim 6, wherein the number of the mobile data memories exceeds the number of the partial frames (PFRAMEx, x=1 . . . n).

8. Method as claimed in claim 3, further comprising:
optimizing data transfer between the read/write device and the mobile data memories by adjusting the data rate and the use of each time slot (SLOT) within the partial frame (PFRAME=SLOT1+SLOT2+. . . +SLOTm) differently for any of the plurality of partial frames (PFRAMEx, x=1 . . . n) and thus for any respective one of the mobile data memories.

9. Method as claimed in claim 8, wherein the uses of each time slot include transmitting data, transmitting instructions, and receiving data.

10. Method as claimed in claim 1, wherein data signals transferred between the mobile data memory and the read/write device have a non-linear code.

11. Method as claimed in claim 1, further comprising:
detecting a collision in the read/write device if two or more different data memories send data signals simultaneously to occupy a provided and available partial frame (PFRAMEx, x=1 . . . n).

12. Method as claimed in claim 11, further comprising:
if a collision is detected, assigning a random number to each of the different mobile data memories that determines a transmittal time for the respective different mobile data memories to retransmit data signals to the read/write device.

13. Method as claimed in either one of claim 11, wherein, if a collision occurs, there is a defined number of renewed transmittal attempts to send the data signals from the respective mobile data memories to the read/write device.

14. Identification system, comprising:
a read write device;
a plurality of objects in motion; and
a plurality of mobile data memories correlated with said objects;
wherein said read write device is configured with at least one of hardware or software to transmit wakeup codes to said mobile data memories during beginning parts of respective time slots and to transfer data between said read write device and said mobile data memories during remaining parts of the respective time slots; and
wherein a plurality of the respective time slots are combined into a partial frame and a plurality of the partial frames are combined into a frame, a plurality of the frames being respectively consecutive in time and coordinated in duration.

15. System as claimed in claim 14, wherein the identification system is a component of at least one of a dispatch, transport or manufacturing system.
